(19) United States
(12) Patent Application Publication
(10) Pub. No.: US 2021/0390526 A1
(43) Pub. Date: Dec. 16, 2021

(54) Validating a transaction relating to an offer for a good or a service to a user

(71) Applicant: ORANGE, Issy-les-Moulineaux (FR)

(72) Inventors: Baptiste François Hemery, Chatillon Cedex (FR); Fabrice Jeanne, Chatillon Cedex (FR); Céline Deleforterie, Chatillon Cedex (FR)

(21) Appl. No.: 17/346,811

(22) Filed: Jun. 14, 2021

(30) Foreign Application Priority Data
Jun. 15, 2020 (FR) 2006206

(51) Int. Cl. G06Q 20/24; G06Q 20/14; G06Q 30/04; G06Q 40/00

(52) U.S. Cl. CPC G06Q 20/24; G06Q 40/12; G06Q 30/04; G06Q 20/14

(57) ABSTRACT

A method for validating a transaction relating to an offer for a good or a service to at least one user, a bill having been generated for the offer, in which the method is implemented in a terminal associated with the user. The method includes, in a manner that is deferred with respect to the offer: accessing, via a communication network, a billing device, using an identifier associated with a set of bills including the bill, the bills of the set relating to goods or services offered to the user by the same provider over a certain period of time; and requesting, with the billing device, payment of at least the bill, taking into account the identifier, a payment method, and an amount written on the at least one bill.

### FIELD OF THE INVENTION

The present invention relates generally to the field of technologies used for the implementation of payment services, and in particular of digital currency, mobile payment, and prepaid payment services, by card or otherwise. It relates more particularly to the validation of a transaction relating to an offer for a good or a service to a user, in a manner that is deferred with respect to said offer, and to the corresponding tracking of billing.

### PRIOR ART

In the context of sales of goods and/or services, a trust relationship may be established between a regular customer and their provider. The provider may then authorize this customer to pay for one or more of their purchases in a deferred manner, during a next physical meeting. For example, the customer will be able to pay for all of the purchases that they make regularly with their provider only at the end of the month, rather than at the time. To that end, the provider has to keep track of the goods/services acquired by the customer in a list generally in paper format (a notebook, repositionable sticky notes, etc.). The advantage of this kind of practice is the reduction in payment-related time.

However, such deferred payment offers no security for the provider. Indeed, deferred payment depends on the goodwill of the customer, which may lead to unpaid bills if the customer decides not to pay their provider. In addition, the provider has to adhere to a monitoring and tracking mechanism for purchases made by the customer, whether manual or computerized, which remains complicated and tedious for the provider, who risks losing the bills that they have edited or not knowing how to properly use existing billing software to perform such monitoring and tracking.

### AIM AND SUMMARY OF THE INVENTION

One of the aims of the invention is to overcome drawbacks of the abovementioned prior art by providing an automated tracking mechanism for a user's purchases from one and the same provider and for monitoring that the payment for these purchases is executed smoothly, by virtue of communication interactions between the following various communication means:
a billing device,
a communication terminal associated with at least one user who makes the purchases,
a communication terminal associated with a provider from whom this user makes their purchases.

To that end, one subject of the present invention relates to a method for validating a transaction relating to an offer for a good or a service to at least one user, a bill having been generated for the offer, in which the method is implemented in a terminal associated with the user.

Such a method is noteworthy in that it comprises the following, in a manner that is deferred with respect to the offer:
accessing, via a communication network, a billing device, using an identifier associated with a set of bills comprising said bill, the bills of said set relating to goods or services offered to the user by the same provider over a certain period of time,
requesting, with the billing device, the payment of at least said bill, taking into account said identifier, a payment method, and an amount written on said at least one bill.

By virtue of the invention, a user who has obtained goods or services from the same provider cumulatively over time, without having paid for these goods or services, has the possibility of paying later for all or only part of the goods or services that have been provided to them, by means of a communication interaction between a terminal of the user and a billing device that has previously stored all of the bills relating to the provision of these goods and/or services to the user.

For the debtor user, such an interaction allows simplified management of the payment for their purchases from one and the same provider. Indeed, the deferred validation of the transactions relating to their purchases via a server which centralizes the bills linking the user to the same provider means that the user does not spend too much time in the store/shop/point of sale of this provider in order to pay for their purchases. Such simplified management of payment for purchases also provides greater security for the provider, for whom the risk of non-payment is decreased, and simpler and more reliable tracking of their billing.

According to one particular embodiment, said at least one bill being one of a plurality of bills to be paid in said set, said payment request takes into account said identifier, said payment method for some of the bills to be paid of said plurality, the cumulative amount of said certain bills, and at least one other payment method for the other bills to be paid of said plurality, and the cumulative amount of said other bills.

This embodiment advantageously allows the user to use split payment means for the deferred payment of the bills which link them to one and the same provider.

According to another particular embodiment, said at least one bill being one of a plurality of bills to be paid in said set, the method comprises the following at a terminal associated with another user sharing the payment of the bills of said set with said user:
accessing the billing device, via a communication network, using said identifier or another identifier associated with said set of bills, said identifier or said other identifier being associated with said other user,
requesting, with the billing device, the payment of at least one other bill of said set, different from said at least one bill, taking into account said identifier or said other identifier, a payment method associated with said at least one other bill, and an amount written on said at least one other bill.

This embodiment advantageously allows at least two users to share the payment for their purchases made jointly with one and the same provider of goods or services.

According to yet another particular embodiment, the time when the action of requesting payment with the billing device is triggered is configurable in the billing device.

This embodiment advantageously allows the user to choose a preferred date for sending their payment request to the billing device. On this date, the billing device will send a payment request to the user's terminal, which will trigger the automatic sending, by the terminal, of the payment request to the billing device. In this way, the payment of the one or more bills that the user owes to the provider may thus be automated, which limits the risk of non-payment for the provider.

According to yet another particular embodiment, said set of bills being associated with an identifier of a provider that has provided the good or the service to said at least one user, it comprises the following at the billing device:
receiving, from a terminal associated with said provider, via a communication network, a message indicating that the payment of said at least one bill or of said bills of said set has been made to said provider,
updating said set of bills, distinguishing the one or more bills still to be paid from said at least one bill that has or from said bills that have been paid.

This embodiment advantageously allows centralization, at the billing device, of the billing and of the tracking thereof, without the provider, or the user or those who share the payment of bills with them, having to intervene in such operations, which represents a saving of time in the processing of their one or more bills.

The various abovementioned embodiments or implementation features may be added, independently or in combination with one another, to the method for validating a transaction defined above.

The invention also relates to a communication terminal for implementing the validation of a transaction relating to an offer for a good or a service to at least one user, a bill having been generated for the offer, the terminal being associated with said user and comprising a processor that is configured to implement the following, in a manner that is deferred with respect to the offer:
accessing, via a communication network, a billing device, using an identifier associated with a set of bills comprising said bill, the bills of the set relating to goods or services offered to the user by the same provider over a certain period of time,
requesting, with the billing device, the payment of at least said bill, taking into account said identifier, a payment method, and an amount written on said at least one bill.

The invention also relates to a billing device comprising a memory for storing bills.

Such a device is noteworthy in that it comprises a processor that is configured to implement the following, in a manner that is deferred with respect to an offer for a good or a service to at least one user by a provider:
generating a bill relating to the offer, in response to a request received from a terminal associated with the provider, the request containing an identifier of said at least one user and an identifier of the provider,
storing the bill in the memory, the bill being added to a set of bills that relate to goods or services offered to said at least one user by the provider for a certain period of time, said set being associated with an identifier dependent on the identifiers received in the request,
receiving, from a terminal associated with said at least user, via a communication network:
   a request to access the billing device, said access request comprising the identifier associated with said set,
   a request for payment of at least said bill of said set, taking into account the identifier associated with said set, a payment method, and an amount written on said at least one bill,
activating said payment in response to the received payment request.

The invention also relates to a billing system, wherein it comprises the abovementioned communication terminal and billing device.

The invention also relates to a computer program comprising instructions for implementing the method for validating a transaction according to the invention, according to any one of the particular embodiments described above, when said program is executed by a processor.

Such instructions may be stored lastingly in a non-transient memory medium of the communication terminal implementing the abovementioned method for validating a transaction.

This program may use any programming language and be in the form of source code, object code or intermediate code between source code and object code, such as in a partially compiled form, or in any other desirable form.

The invention also targets a computer-readable storage medium or information medium containing instructions of a computer program, such as mentioned above. The storage medium may be any entity or device capable of storing the program. For example, the medium may contain a storage means, such as a ROM, for example a CD-ROM or a microelectronic circuit ROM, or else a magnetic storage means, for example a USB key or a hard drive.

Moreover, the storage medium may be a transmissible medium such as an electrical or optical signal, which may be conveyed via an electrical or optical cable, by radio or by other means. The program according to the invention may in particular be downloaded from an Internet network.

As an alternative, the storage medium may be an integrated circuit in which the program is incorporated, the circuit being designed to execute or to be used in the execution of the abovementioned method for validating a transaction.

### BRIEF DESCRIPTION OF THE DRAWINGS

Other features and advantages will become apparent from reading particular embodiments of the invention, which are given by way of illustrative and non-limiting examples, and the appended drawings, in which:

FIG. 1 shows a billing system according to a first embodiment of the invention, in which the method for validating a transaction of the invention is implemented,

FIG. 2 shows a billing device in one particular embodiment of the invention,

FIG. 3 shows a communication terminal associated with a provider of goods and/or services, in one particular embodiment of the invention,

FIG. 4 shows a communication terminal associated with a user purchasing a good and/or a service, in one particular embodiment of the invention,

FIG. 5 shows the main actions implemented in a phase of adding one or more bills which precedes the transaction validation method, according to one particular embodiment of the invention,

FIG. 6 shows the main actions implemented in a phase of validating one or more bills which precedes the transaction validation method, according to one particular embodiment of the invention,

FIG. 7A shows the main actions implemented in the transaction validation method, according to a first particular embodiment of the invention,

FIG. 7B shows the main actions implemented in the transaction validation method, according to a second particular embodiment of the invention,

FIG. 7C shows the main actions implemented in the transaction validation method, according to a third particular embodiment of the invention,

FIG. 8 shows a billing system according to a second embodiment of the invention, in which the method for validating a transaction of the invention is implemented,

FIG. 9 shows the main actions implemented in a phase of validating one or more bills which precedes the transaction validation method, in the billing system of FIG. 8,

FIG. 10A shows the main actions implemented in the transaction validation method, according to a first particular embodiment of the billing system of FIG. 8,

FIG. 10B shows the main actions implemented in the transaction validation method, according to a second embodiment of the billing system of FIG. 8.

### DETAILED DESCRIPTION OF A FIRST EMBODIMENT OF THE INVENTION

### Architectural Environment

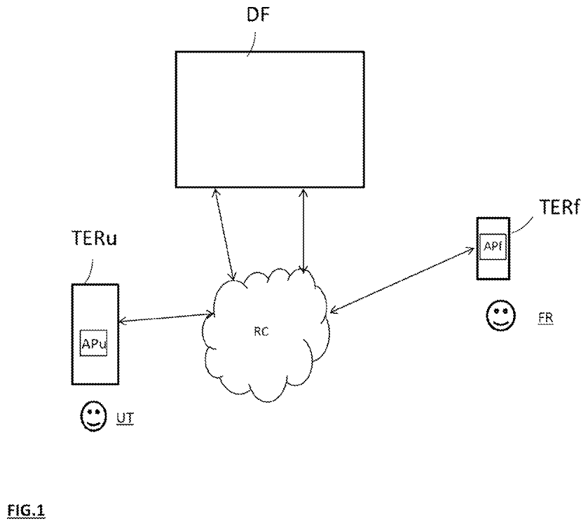

FIG. 1 shows an environment in which the method for validating a transaction according to the invention is implemented.

Such an environment comprises:
a communication terminal TERf associated with a provider FR of one or more products and/or services,
a communication terminal TERu associated with a user UT, a customer of the provider FR,
a device DF for billing the purchases made by the user UT with the provider FR.

The terminals TERu and TERf communicate with the billing device DF via a communication network RC. It may for example be an IP (abbreviation for “Internet Protocol”) network, an x-DSL (abbreviation for “Digital Subscriber Line”) network, fiber network or a 3G, 4G, 5G, etc. network.

In FIG. 1, the billing device DF is shown as a distinct entity from the terminal TERf. However, according to another implementation, the billing device DF could be integrated into the terminal TERf to form a single entity.

By way of non-exhaustive examples, the terminals TERu and TERf are:
a cellphone, and/or
a smartphone, and/or
a tablet, and/or
a laptop, and/or
a personal computer of PC type, and/or
etc.

The terminal TERu comprises a software application (or application program) APu for interacting with the billing device DF, the application APu being dedicated to implementing the method for validating a transaction in accordance with the present invention. The application APu is downloaded into the terminal TERu, for example upstream of the execution of the method for validating a transaction.

The terminal TERu is associated with an identifier IDu such as for example:
an address (IP, public),
a notification/push identifier,
an email address of the user UT,
the MSISDN (Mobile Station International Subscriber Directory Number) number of the user UT,
the IBAN (International Bank Account Number) number of the user UT,
or else any type of identifier, for example an identifier generated by the application APu.

The terminal TERf also comprises a corresponding software application (or application program) APf for interacting with the billing device DF, the application APf being dedicated to adding bills to the billing device DF, and to monitoring the tracking of these bills, in the context of the implementation of the method for validating a transaction in accordance with the present invention. The application APf is downloaded into the terminal TERf, upstream of the execution of the method for validating a transaction.

The terminal TERf is associated with an identifier IDf such as for example:
an address (IP, public),
a notification/push identifier,
an email address of the provider FR,
the MSISDN (Mobile Station International Subscriber Directory Number) number of the provider FR,
the IBAN (International Bank Account Number) number of the provider FR,
or else any type of identifier, for example an identifier generated by the application APf.

### Description of One Embodiment of the Billing Device DF

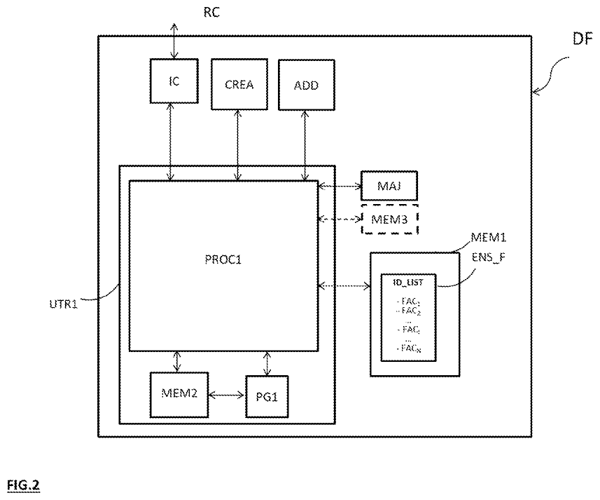

FIG. 2 presents the simplified structure of the billing device DF. It is for example a server.

Such a device allows, in a manner that is deferred with respect to the acquisition of a good and/or service by the user UT from the provider FR:
generation, via the module CREA, of a set or list ENS_F of bills, the set ENS_F being stored in a memory MEM1,
adding, via the module ADD, of at least one bill FACT (1≤i≤N) corresponding to the acquisition of a good and/or service by the user UT from the provider FR, to the set ENS_F grouping together the bills relating to the acquisition, from the provider FR, by the user UT, of one or more goods and/or services, for a certain period of time (for example, week, month, year),
updating, via the module MAJ, of the status of the bills (status: to be paid, paid, free, etc.) of the set ENS_F of bills.

In the embodiment shown in FIG. 2, the memory MEM1 is integrated into the billing device DF. As a variant, the memory MEM1 could be a database external to the billing device DF and made accessible to the latter.

In the event that the user UT acquires goods and/or services from several different providers, the memory M1 may of course store several sets of bills in connection with these different providers. Additionally, in the event that the provider FR sells goods and/or services to several different users, the memory M1 may of course store several sets of bills in connection with these different users.

The billing device DF also comprises a communication interface IC which is suitable for communicating, via the communication network RC, with the terminal TERu of the user UT or the terminal TERf of the provider FR, using for example IP protocol, x-DSL, fiber, 3G, 4G, 5G, etc., Wi-Fi, PLC (“Power-Line Communication”), or others.

Thus, the billing device DF is accessible:
by the user UT so that they may consult, validate/dispute and pay the bills of the set of bills ENS_F,
by the provider FR so that they may request, from the device DF, the addition, to the set ENS_F of bills, of a bill relating to the acquisition of a good and/or service by the user UT, consult this set, and potentially request the payment of all or part of the bills of this set.

Optionally, the billing device DF comprises a memory MEM3 in which is stored, prior to the execution of the method for validating a transaction according to the invention, certain information such as for example:
the physical or bank details of the user UT,
the status of the bills,
the one or more payment methods preferred by the user UT,
the type of notification that the user UT wishes to receive from the billing device DF (for example, “no notification desired”, “text notification only”, etc.).

According to one particular embodiment of the invention, the actions performed by the billing device DF are implemented by instructions of a computer program PG1.

To that end, the device DF has the conventional architecture of a computer and comprises in particular a memory MEM2, a processing unit UTR1, equipped for example with a processor PROC1, and driven by the computer program PG1 stored in memory MEM2. The computer program PG1 comprises instructions for performing the actions of generating the set ENS_F of bills, of adding bills to this set, and of updating this set, in the context of the method for validating a transaction which will be described below, when the program is executed by the processor PROC1, according to any one of the particular embodiments of the invention.

On initialization, the code instructions of the computer program PG1 are for example loaded into a RAM memory (not shown) before being executed by the processor PROC1. The processor PROC1 of the processing unit UTR1 implements in particular the aforementioned actions, according to the instructions of the computer program PG1.

### Description of One Embodiment of the Communication Terminal TERf

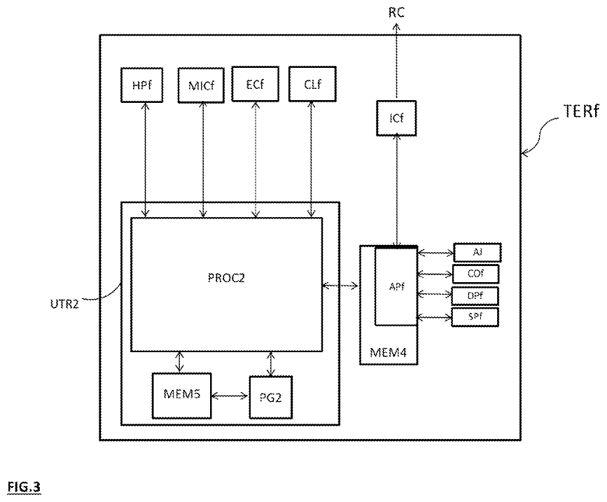

FIG. 3 presents the simplified structure of the communication terminal TERf associated with the provider FR.

The communication terminal TERf conventionally comprises:
a display screen ECf,
a speaker HPf,
a microphone MICf,
a keyboard CLf.

According to the invention, the terminal TERf stores the aforementioned application APf in a memory MEM4.

The application APf is composed of the following software components:
an interface AJ for adding at least one bill FACᵢ to the set ENS_F of bills,
an interface COf for consulting the set ENS_F of bills,
an interface DPf for requesting payment of all or part of the bills FAC₁ to FAC_{N} of the set ENS_F of bills,
an interface SPf for entering preferences,
an interface ICf for communicating with the billing device DF, the interface ICf being suitable for operating using, for example, IP protocol, x-DSL, fiber, 3G, 4G, 5G, etc., Wi-Fi, CPL, or others.

In one particular embodiment, the application APf could be directly integrated into an existing billing application, such as, for example, cash register software.

According to one particular embodiment of the invention, the actions executed by the application APf, in the context of implementing the method for validating a transaction in accordance with the present invention, are implemented by instructions of a computer program PG2. To that end, the terminal TERf has the conventional architecture of a computer and comprises in particular a memory MEM5, a processing unit UTR2, equipped for example with a processor PROC2, and driven by the computer program PG2 stored in memory MEM5. The computer program PG2 comprises instructions for implementing the actions executed by the application APf, when the program is executed by the processor PROC2, according to any one of the particular embodiments of the invention.

On initialization, the code instructions of the computer program PG2 are for example loaded into a RAM memory (not shown) before being executed by the processor PROC2. The processor PROC2 of the processing unit UTR2 implements in particular the actions of adding bills to the billing device DF, and of monitoring the tracking of these bills, according to the instructions of the computer program PG2.

### Description of One Embodiment of the Communication terminal TERu

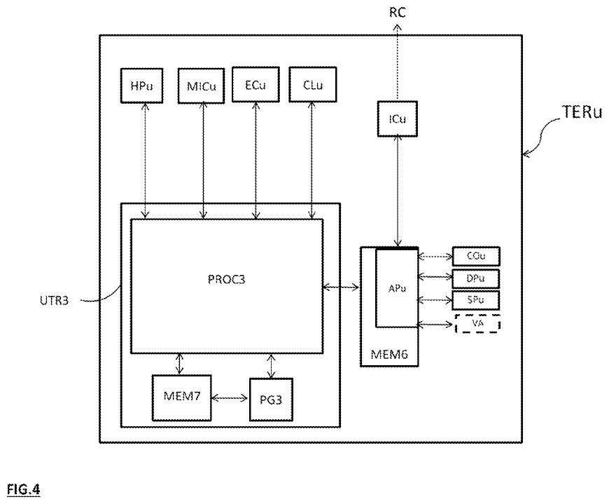

FIG. 4 presents the simplified structure of the communication terminal TERu associated with the user UT.

The communication terminal TERu conventionally comprises:
a display screen ECu,
a speaker HPu,
a microphone MICu,
a keyboard CLu.

According to the invention, the terminal TERu stores the aforementioned application APu in a memory MEM6.

The application APu is composed of the following software components:
an interface COu for consulting the set ENS_F of bills,
an interface DPu for requesting payment of all or part of the bills FAC₁ to FAC_{N} of the set ENS_F of bills,
an interface SPu for entering preferences,
an interface ICu for communicating with the billing device DF, the interface ICu being suitable for operating using, for example, IP protocol, x-DSL, fiber, 3G, 4G, 5G, etc., Wi-Fi, CPL, or others,
optionally, an interface VA for validating at least one bill FACᵢ of the set ENS_F of bills.

In one particular embodiment, the application APu could be directly integrated into a specific payment application, installed on the terminal TERu.

Since the interface VA is optional, it is shown in dashed lines in FIG. 4.

According to one particular embodiment of the invention, the actions executed by the application APu, in the context of implementing the method for validating a transaction in accordance with the present invention, are implemented by instructions of a computer program PG3. To that end, the terminal TERu has the conventional architecture of a computer and comprises in particular a memory MEM5, a processing unit UTR2, equipped for example with a processor PROC3, and driven by the computer program PG3 stored in memory MEM7. The computer program PG3 comprises instructions for implementing the actions executed by the application APu, when the program is executed by the processor PROC3, according to any one of the particular embodiments of the invention.

On initialization, the code instructions of the computer program PG3 are for example loaded into a RAM memory (not shown) before being executed by the processor PROC3. The processor PROC3 of the processing unit UTR3 implements the management of the bills FAC₁ to FAC_{N} by the user UT, and more particularly the actions of validating a transaction with the billing device DF, according to the instructions of the computer program PG3.

### Description of One Embodiment of a Preliminary Phase of Adding One or More Bills

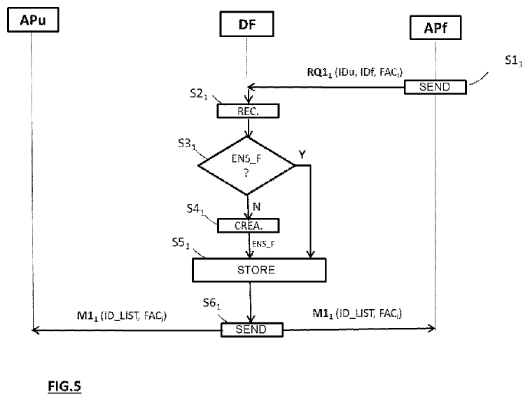

With reference to FIG. 5, the execution of a method for adding at least one bill FACT according to one embodiment of the invention, implemented in the billing system of FIG. 1, will now be described.

The user UT and the provider FR have previously registered with the billing device DF. Such registration is implemented conventionally, for example via a dedicated webpage. During this registration, the user UT and the provider FR provided the device DF with their respective identifiers IDu and IDf, which were stored in the device DF, for example in the memory M1 (FIG. 2).

The bill-adding method is implemented in a manner that is deferred with respect to the acquisition of a good and/or service acquired by the user UT from the provider FR of this good and/or service.

In the context of the invention, the acquired good and/or service is not paid for by the user UT at the time of its acquisition.

According to one example, the user UT has physically visited the provider FR to acquire the good and/or service. According to another example, the user UT has acquired the good and/or service remotely, for example via a website of the provider FR.

During this acquisition, the user UT shared, with the provider FR, an identifier, such as for example one of the aforementioned identifiers IDu, or else a single-use variant that can be decoded by the billing device DF.

Such sharing may be achieved in several ways: verbally, or via the terminal TERu, using a visual element, such as for example a barcode, a QR (abbreviation for “Quick Response”) code, etc., or else using any other communication channel, for example NSDT (abbreviation for “Near Sound Data Transfer”), NFC (abbreviation for “Near-Field Communication”).

Once these prerequisites have been met, the method for adding one or more bills comprises the following.

In S1₁, the terminal TERf sends, via the network RC, to the device DF, by means of the interface ICf, a request RQ1₁ to store the bill FACᵢ corresponding to the acquisition of a good and/or service by the user UT. To that end, the provider FR activates the adding interface AJ, enters their identifier IDf, the identifier IDu previously communicated by the user UT during the acquisition, and selects the bill FACᵢ.

In S2₁, the device DF receives the request RQ1₁, via the interface IC.

In S3₁, the device DF checks, on the basis of the received identifiers IDu and IDf, whether the set ENS_F is already stored in its memory M1.

If the set ENS_F is not already stored, in S4₁, the device DF generates, in the memory M1, via the module CREA, a set ENS_F, by assigning it an identifier ID_LIST which is based on the identifiers IDu and IDf received in the request.

In S5₁, the device DF adds the received bill FACᵢ, via its module ADD, to the set ENS_F, associating the “payable” status therewith.

If the set ENS_F is already stored in memory M1, step S5₁ is directly implemented on completion of step S3₁.

In S6₁, the device DF sends the terminals TERu and TERf, via the network RC, by means of its interface IC, a message M1₁ respectively notifying the user UT and the provider FR that a bill FACᵢ has been added to the set ENS_F. To that end, the message M1₁ contains the identifier ID_LIST and an identifier of the bill FACᵢ. The message M1₁ potentially contains the “payable” status of the bill FACᵢ.

In the event that step S4₁is implemented, the device DF could for example firstly notify the user UT and the provider FR that a set of bills ENS_F has been created, and then secondly notify that the bill FACᵢ has been added to the set ENS_F.

Such a method saves time for the provider FR in the management of their bills (monitoring and tracking). The latter may thus:
feed more customers through checkout within a given time,
have more time to devote to other users (advise on goods, perform a service, etc.) or to other users who do not have the application APu.

Consequently, improved user satisfaction results, with a higher probability that they will return to shop with the provider FR, rather than with another provider.

In addition, in the event that the application APf is downloaded into cash register software, it is possible for the provider FR, using the cash register software, not only to scan/save the products/services consumed by the user UT in the cash register software, but also to send the one or more corresponding bills to the billing device DF, via the communication network RC, without then having to change software. The task of managing bills for the provider FR, which is centralized only in the cash register software, is therefore greatly facilitated.

### Description of One Embodiment of a Preliminary Phase of Validating One or More Bills

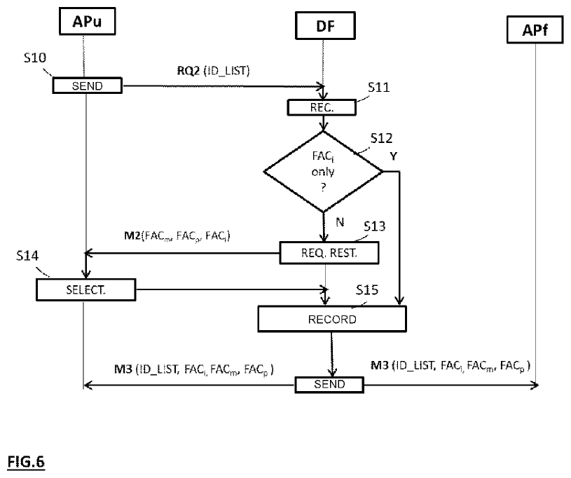

With reference to FIG. 6, the execution of a method for validating bills according to one embodiment of the invention, implemented in the billing system of FIG. 1, will now be described.

Such a method is optional, the user UT being able to go directly to validating the transaction. Indeed, according to one particular implementation, the user UT could, by means of their terminal TERu, via the interface for entering preferences SPu, request the device DF to automatically validate the bills added to the set ENS_F.

In the event that the method for validating one or more bills is implemented, in S10, the terminal TERu sends, via the network RC, to the device DF, by means of the interface ICu, a request RQ2 to validate at least the bill FACᵢ. To that end, the user UT activates the validation interface VA, and enters the identifier ID_LIST.

In S11, the device DF receives the request RQ2, via the interface IC.

In S12, the device DF checks, in the set ENS_F, whether or not the bill FACT is the only one to have “payable” status.

If several other bills have “payable” status, the device DF sends, in S13, the terminal TERu a message M2 indicating the list of the bills to be paid, including the bill FACᵢ. In the example shown, three bills FACₘ, FACₚ and FACᵢ are payable, such that 1≤m≤N and 1≤p≤N.

In S14, the user UT accesses the bills FACₘ, FACₚ and FACᵢ via the interface COu of the application APu, and selects, via the interface VAL, the bill FACᵢ, and potentially the bill FACₘ and/or the bill FACp which are to be paid, as one or more bills to be validated. The act of selecting corresponds here to validation, by the user UT, of the recognition of debts that the latter has with respect to the provider FR. In S15, the device DF records the validation of the bill FACᵢ and potentially of the bills FACₘ and/or FACp, if they have been selected.

In S16, the device DF sends the terminals TERu and TERf, via the network RC, by means of its interface IC, a message M3 respectively notifying the user UT and the provider FR that the bill FACT and potentially the bills FACₘ and FACₚ has/have been validated by the user UT.

If, on completion of step S12, only the bill FACT has “payable” status, the device DF goes directly to recording S15 the validation of the bill FACᵢ.

### Description of a First Embodiment of a Method for Validating a Transaction

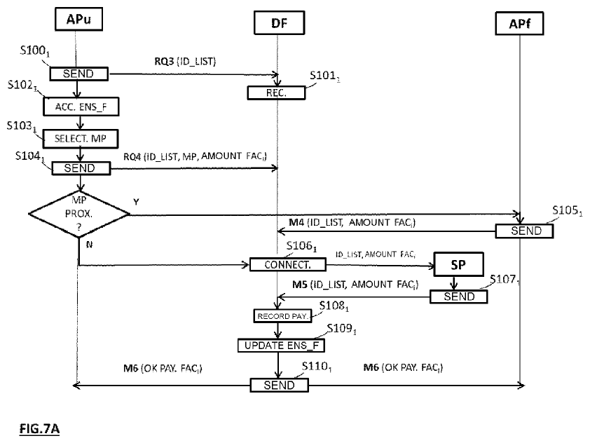

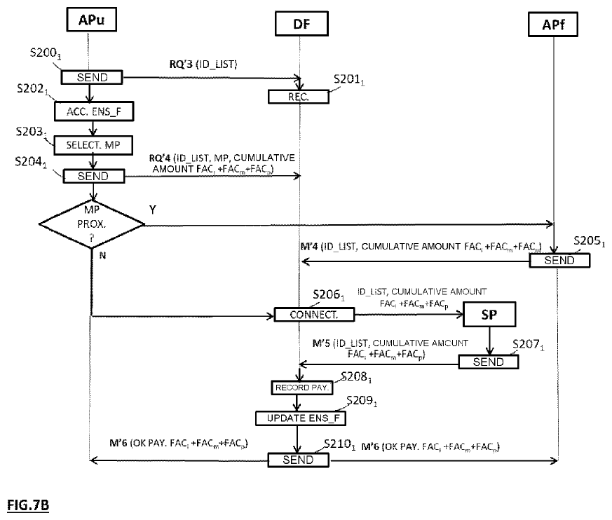

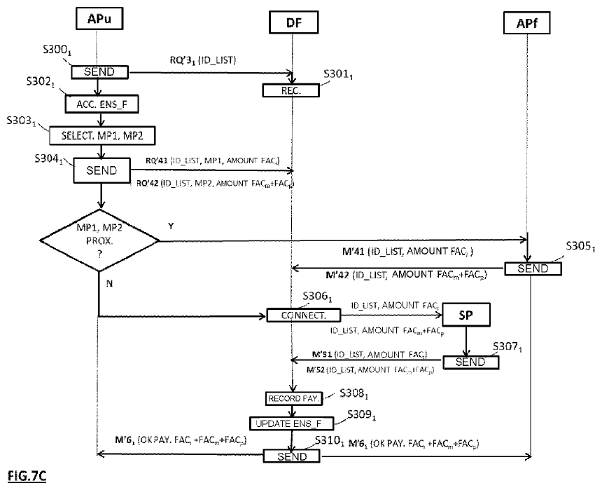

With reference to FIG. 7A, the execution of a method for validating a transaction according to a first embodiment of the invention, implemented in the billing system of FIG. 1, will now be described.

In the example illustrated, the validation of the transaction corresponds to the payment of a single bill FACᵢ of the set of bills ENS_F, from among other bills to be paid.

In S100₁, the terminal TERu sends, via the network RC, to the device DF, by means of the interface ICu, a request RQ3 to pay the bill FACᵢ. To that end, the user UT activates the consultation interface COu, and enters the identifier ID_LIST.

The sending of such a request RQ3 is here implemented on the initiative of the user UT, by means of the terminal TERu.

Other implementations are of course possible, making the billing system according to the invention particularly flexible from a use perspective. The request RQ3 may for example be sent in response to a request from the device DF asking the user UT to pay their bill. The sending of the request by the device DF to the terminal TERu may be triggered at the request of the terminal TERf. To that end, the provider FR, having consulted the device DF, via the interface COf, as to the bills to be paid in the set ENS_F, may activate the payment request interface DPf in order to request that the device DF send a request for payment to the terminal TERu. In one particular implementation, by means of the interface SPf for entering preferences, the provider FR may even configure the device DF so that, at a time decided by the provider FR (immediate request, weekly recurrent request, monthly request, etc.), the device DF automatically sends the request for payment to the terminal TERu. In another particular implementation, it is the user UT who configures the device DF to automatically trigger the sending of the payment request RQ3 to the billing device DF at a time decided by the user UT. To that end, the user UT, having consulted the device DF, via the interface COu, as to the bills to be paid in the set ENS_F, may activate the interface for entering preferences SPu in order to request that the device DF send a request for payment of the bill FACᵢ to the terminal TERu. The user UT may configure the device DF so that, at a time decided by the user UT (e.g. the day for which the bill FACᵢ is recorded in the device DF, on a set day of the week or of the month, etc.), the device DF automatically sends the terminal TERu the request for payment, so as to automatically trigger the sending, by the terminal TERu to the device DF, of the payment request RQ3.

This type of configuration thus advantageously makes it possible, for the provider FR, to limit the risk of non-payment, and for the user UT, of forgetting to pay their bills.

In S101₁, the device DF receives the request RQ3, via the interface IC.

In S102₁, the user UT accesses, via the interface COu of the application APu, the set of bills ENS_F comprising in particular the bill FACᵢ that has “payable” status.

In S103₁, the user UT selects a payment method MP by means of the interface SPu.

Such a selection may of course be configured by the user UT before the execution of the method for validating the transaction, as a prerequisite.

In S104₁, by means of the interface DPu, the user UT sends the device DF a request RQ4 to activate the payment of the bill FACᵢ, said request RQ4 containing the identifier ID_LIST, the amount of the bill FACᵢ and the selected payment method MP.

If the payment method MP is a proximity payment method, such as for example payment by cash, check, bank card, restaurant vouchers, or any other means of payment available to the provider FR, once the user UT has paid the bill FACᵢ using this payment method, in S105₁, the terminal TERf sends the device DF, via the network RC, by means of its interface ICf, a message M4 notifying of the validation of the payment of the amount of the bill FACᵢ, the message M4 containing the identifier ID_LIST and the amount of the bill FACᵢ.

If the payment method MP is a remote payment method, such as for example transfer, direct debit, remote payment by bank card, 3D Secure payment, payment via a telephone subscription bill, mobile-to-mobile payment or any other specific remote payment method, in S106₁, the device DF puts the terminal TERu in contact with a payment server SP in order to perform the remote payment by communicating, to the payment server SP, the identifier ID_LIST and the amount of the bill FACᵢ.

In S107₁, the payment server SP sends the device DF a message M5 notifying of the validation of the payment of the amount of the bill FACᵢ, the message M5 containing the identifier ID_LIST and the amount of the bill FACᵢ.

In S108₁, the device DF records the payment made.

In S109₁, the device DF activates the update module MAJ in order to update the set ENS_F, by changing the “payable” status of the bill FACᵢ to “paid” status, and updates the amount due for the bills that have not yet been paid in the set ENS_F.

In S110₁, the device DF sends the terminals TERu and TERf, via the network RC, by means of its interface IC, a message M6 indicating that the bill FACᵢ has been paid.

To that end, the message M6 contains the identifier ID_LIST and an identifier of the bill FACᵢ.

### Description of a Second Embodiment of a Method for Validating a Transaction

With reference to FIG. 7B, the execution of a method for validating a transaction according to a second embodiment of the invention, implemented in the billing system of FIG. 1, will now be described.

In the example illustrated, the validation of the transaction corresponds to the payment of several bills that have “payable” status of the set of bills ENS_F, for example the bills FACᵢ, FACₘ and FACₚ.

In S200₁, the terminal TERu sends, via the network RC, to the device DF, by means of the interface ICu, a request RQ′3 to pay the cumulative amount of the bills FACᵢ, FACₘ and FACₚ. To that end, the user UT activates the consultation interface COu, and enters the identifier ID_LIST.

The sending of such a request RQ′3 is here implemented on the initiative of the user UT, by means of the terminal TERu. The sending of the request RQ′3 may be configured as described in relation to the first embodiment above.

In S201₁, the device DF receives the request RQ′3, via the interface IC.

In S202₁, the user UT accesses, via the interface COu of the application APu, the set of bills ENS_F comprising in particular the bills FACᵢ, FACₘ and FACₚ that have “payable” status.

In S203₁, the user UT selects a payment method MP by means of the interface SPu.

Such a selection may of course be configured by the user UT before the execution of the method for validating the transaction, as a prerequisite.

In S204₁, by means of the interface DPu, the user UT sends the device DF a request RQ′to activate the payment of the bill FACᵢ, said request RQ′4 containing the identifier ID_LIST, the cumulative amount of the bills FACᵢ, FACₘ and FACₚ and the selected payment method MP.

If the payment method MP is a proximity payment method, such as for example payment by cash, check, bank card, restaurant vouchers, or any other means of payment available to the provider FR, once the user UT has paid all of the bills FACᵢ, FACₘ and FACₚ using this payment method, in S205₁, the terminal TERf sends the device DF, via the network RC, by means of its interface ICf, a message M′4 notifying of the validation of the payment of the cumulative amount of the bills FACᵢ, FACₘ and FACₚ, the message M′4 containing the identifier ID_LIST and the cumulative amount of the bills FACᵢ, FACₘ and FACₚ.

If the payment method MP is a remote payment method, such as for example transfer, direct debit, remote payment by bank card, 3D Secure payment, payment via a telephone subscription bill, mobile-to-mobile payment or any other specific remote payment method, in S206₁, the device DF puts the terminal TERu in contact with a payment server SP in order to perform the remote payment by communicating, to the payment server SP, the identifier ID_LIST and the cumulative amount of the bills FACᵢ, FACₘ and FACₚ.

In S207₁, the payment server SP sends the device DF a message M′5 notifying of the validation of the payment of the cumulative amount of the bills FACᵢ, FACₘ and FACₚ, the message M′5 containing the identifier ID_LIST and the cumulative amount of the bills FACᵢ, FACₘ and FACₚ.

In S208₁, the device DF records the payment made.

In S209₁, the device DF activates the update module MAJ in order to update the set ENS_F, by changing the “payable” status of the bills FACᵢ, FACₘ and FACₚ to “paid” status, and updates the amount due for the bills that have not yet been paid in the set ENS_F.

In S210₁, the device DF sends the terminals TERu and TERf, via the network RC, by means of its interface IC, a message M′6 indicating that the bills FACᵢ, FACₘ and FACₚ have been paid. To that end, the message M′6 contains the identifier ID_LIST and an identifier of the bills FACᵢ, FACₘ and FACₚ.

### Description of a Third Embodiment of a Method for Validating a Transaction

With reference to FIG. 7C, the execution of a method for validating a transaction according to a third embodiment of the invention, implemented in the billing system of FIG. 1, will now be described.

In the example illustrated, the validation of the transaction corresponds to the payment of several bills that have “payable” status of the set of bills ENS_F, for example the bills FACᵢ, FACₘ and FACₚ, the user UT using at least two different payment methods MP1 and MP2 to pay these bills.

In S300₁, the terminal TERu sends, via the network RC, to the device DF, by means of the interface ICu, a request RQ′3₁ to pay the cumulative amount of the bills FACᵢ, FACₘ and FACₚ. To that end, the user UT activates the consultation interface COu, and enters the identifier ID_LIST.

The sending of such a request RQ′3₁ is here implemented on the initiative of the user UT, by means of the terminal TERu. The sending of the request RQ′3₁ may be configured as described in relation to the first embodiment above.

In S301₁, the device DF receives the request RQ′3₁, via the interface IC.

In S302₁, the user UT accesses, via the interface COu of the application APu, the set of bills ENS_F comprising in particular the bills FACᵢ, FACₘ and FACₚ that have “payable” status.

In S303₁, the user UT selects, by means of the interface SPu, the payment method MP1 for paying, for example, the bill FACᵢ and the payment method MP2 for paying, for example, the bills FACₘ and FACₚ.

Such a selection may of course be configured by the user UT before the execution of the method for validating the transaction, as a prerequisite.

In S304₁, by means of the interface DPu, the user UT sends the device DF a request RQ′41 to activate the payment of the bill FACᵢ, said request RQ′41 containing the identifier ID_LIST, the amount of the bill FACᵢ and the selected payment method MP1.

If the payment method MP1 is a proximity payment method, such as for example payment by cash, check, bank card, restaurant vouchers, or any other means of payment available to the provider FR, once the user UT has paid the bill FACᵢ using this payment method, in S305₁, the terminal TERf sends the device DF, via the network RC, by means of its interface ICf, a message M′41 notifying of the validation of the payment of the amount of the bill FACᵢ, the message M′41 containing the identifier ID_LIST and the amount of the bill FACᵢ.

If the payment method MP1 is a remote payment method, such as for example transfer, direct debit, remote payment by bank card, 3D Secure payment, payment via a telephone subscription bill, mobile-to-mobile payment or any other specific remote payment method, in S306₁, the device DF puts the terminal TERu in contact with a payment server SP in order to perform the remote payment by communicating, to the payment server SP, the identifier ID_LIST and the amount of the bill FACᵢ.

In S307₁, the payment server SP sends the device DF a message M′51 notifying of the validation of the payment of the amount of the bill FACᵢ, the message M′51 containing the identifier ID_LIST and the amount of the bill FACᵢ.

In S308₁, the device DF records the payment made.

Steps S303₁ to S308₁ are then repeated for the second payment method MP2 selected for the payment of the bills FACₘ and FACₚ.

In S309₁, the device DF activates the update module MAJ in order to update the set ENS_F, by changing the “payable” status of the bills FACᵢ, FACₘ and FACₚ to “paid” status, and updates the amount due for the bills that have not yet been paid in the set ENS_F.

In S310₁, the device DF sends the terminals TERu and TERf, via the network RC, by means of its interface IC, a message M′61 indicating that the bills FACᵢ, FACₘ and FACₚ have been paid. To that end, the message M′61 contains the identifier ID_LIST and an identifier of the bills FACᵢ, FACₘ and FACₚ.

In one particular application of the embodiments described in FIGS. 7A to 7C, the provider FR is for example a grocer and the user UT a regular customer of this grocer, the customer making daily purchases from this grocer, near their home. They make several purchases a week, and a trust relationship has been established between the customer and the grocer. The grocer then proposes that the customer pay for all purchases at the end of the month. To that end:
The customer UT communicates their identifier IDu to the grocer FR, giving them authorization to open a shopping list with their grocer, the identifier IDu being, for example, the identifier of a payment application installed on the customer's terminal TERu.
When the customer UT makes purchases, the grocer FR adds the bill to the list ENS_F and the customer UT validates it if they wish.
The grocer informs the billing device DF that they want their customer to make a payment at the end of the month.
At the end of the month, the billing device DF informs the customer UT that they have to pay their list of bills with the grocer.
The customer UT chooses to make a remote payment from their payment application. They may, from home, pay all or only part of the bills for the month.
The grocer FR receives a notification from the device DF that their customer has paid the due amount, and that the money is available in their account.

### Detailed Description of a Second Embodiment of the Invention

### Architectural Environment

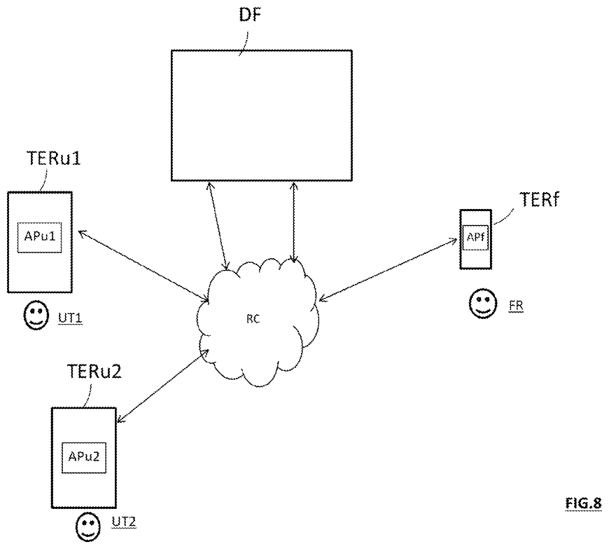

FIG. 8 shows an environment in which the method for validating a transaction according to the invention is implemented, in a second embodiment.

In this second embodiment, two users UT1 and UT2, instead of a single user UT, make group purchases with the provider FR.

To that end, the environment of FIG. 8 differs from that shown in FIG. 1 in that it comprises:
a communication terminal TERu1 associated with a user UT1, a customer of the provider FR,
a communication terminal TERu2 associated with a user UT2, also a customer of the provider FR, and making purchases with the user UT1 as a group.

Since all of the other elements shown in FIG. 8 are identical to those of FIG. 1, they are not described again and bear the same reference numerals.

The terminals TERu1 and TERu2 are similar to the aforementioned terminal TERu.

To that end, the terminal TERu1, respectively TERu2, comprises a software application (or application program) APu1, respectively APu2, for interacting with the billing device DF, the application APu1, respectively APu2, being dedicated to implementing the method for validating a transaction in accordance with the present invention. The application APu1, respectively APu2, is downloaded into the terminal TERu1, respectively TERu2, upstream of the execution of the method for validating a transaction.

The terminal TERu1, respectively TERu2, is associated with an identifier IDu1, respectively IDu2, of the same type as the aforementioned identifier IDu.

### Description of One Embodiment of a Preliminary Phase of Adding One or More Bills

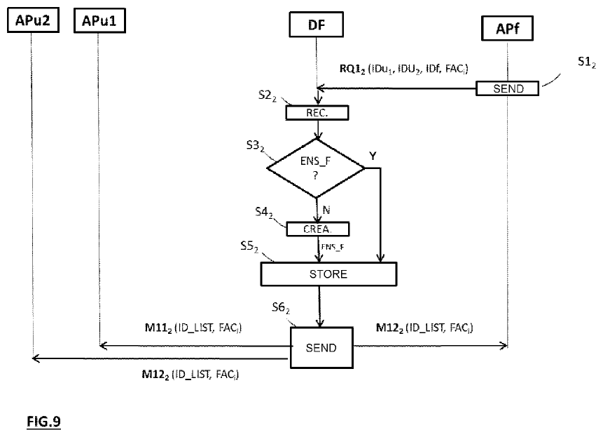

With reference to FIG. 9, the execution of a method for adding at least one bill FACᵢ according to one embodiment of the invention, implemented in the billing system of FIG. 8, will now be described.

The users UT1 and UT2, and the provider FR, have previously registered with the billing device DF, in the same way as has already been explained above with reference to FIG. 5.

According to the second embodiment, during the acquisition of the good and/or service from the provider FR, the users UT1 and UT2 shared their respective identifier IDu1, IDu2 with the provider FR.

Once these prerequisites have been met, the method for adding one or more bills comprises the following:

In S1₂, the terminal TERf sends, via the network RC, to the device DF, by means of the interface ICf, a request RQ1₂ to store the bill FACᵢ corresponding to the group acquisition of the good and/or service by the users UT1 and UT2. To that end, the provider FR activates the addition interface AJ, enters their identifier IDf, the identifier IDu1, respectively IDu2, previously communicated by the user UT1, respectively UT2, during the acquisition, and selects the bill FACᵢ.

In S2₂, the device DF receives the request RQ1₂, via the interface IC.

In S3₂, the device DF checks, on the basis of the received identifiers IDu1, IDu2 and IDf, whether the set ENS_F is already stored in its memory M1.

If the set ENS_F is not already stored, in S4₂, the device DF generates, in the memory M1, via the module CREA, a set ENS_F, by assigning it an identifier ID_LIST which is based on the identifiers IDu1, IDu₂ and IDf received in the request RQ1₂. As a variant, the device DF could generate the set ENS_F by assigning it a first identifier ID_LIST1 which is based on the identifiers IDu1 and IDf and a second identifier ID_LIST2 which is based on the identifiers IDu2 and IDf.

In S5₂, the device DF adds the received bill FACᵢ, via its module ADD, to the set ENS_F, associating the “payable” status therewith.

If the set ENS_F is already stored in memory M1, step S5₂ is directly implemented on completion of step S3₂.

In S6₂, the device DF sends the terminals TERu1, TERu2 and TERf, via the network RC, by means of its interface IC, a message M11₂, M12₂ and M1₂ respectively notifying the user UT1, the user UT2 and the provider FR, that a bill FACᵢ has been added to the set ENS_F. To that end, each of these messages contains the identifier ID_LIST and an identifier of the bill FACᵢ. Each of these messages potentially contains the “payable” status of the bill FACᵢ.

In the event that two identifiers ID_LIST1 and ID_LIST2 have been assigned to the set ENS_F, in S6₂, the device DF notifies these two identifiers in the message M1₂ sent to the terminal TERf, notifies the identifier ID_LIST1 in the message M11₂ sent to the terminal TER_U1 and notifies the identifier ID_LIST2 in the message M12₂ sent to the terminal TERu2.

### Description of One Embodiment of a Preliminary Phase of Validating One or More Bills

Similar to what has been described with reference to FIG. 6, the bill validation method is implemented independently by each terminal TERu1 and TERu2.

### Description of a First Embodiment of a Method for Validating a Transaction

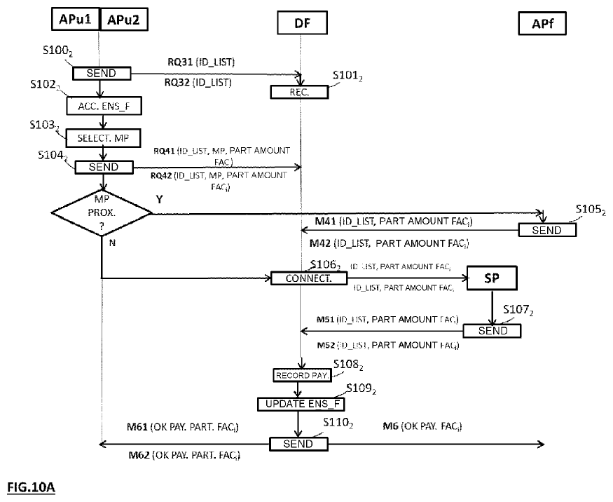

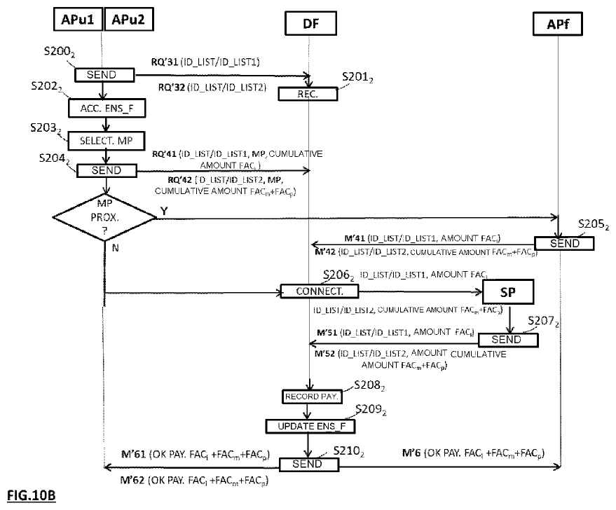

With reference to FIG. 10A, the execution of a method for validating a transaction according to a first embodiment of the invention, implemented in the billing system of FIG. 8, will now be described.

In the example illustrated, the validation of the transaction corresponds to the payment of a single bill FACᵢ of the set of bills ENS_F, from among other bills to be paid. The user UT1 uses their terminal TERu1 to pay the amount of one part of the bill FACᵢ, while the user UT2 uses their terminal TERu2 to pay the amount of the other part of the bill FACT.

In S100₂, the terminal TERu1 sends, via the network RC, to the device DF, by means of the interface ICu, a request RQ31 to pay only part of the bill FACᵢ. To that end, the user UT1 activates the consultation interface COu, and enters the identifier ID_LIST.

The sending of such a request RQ31 is here implemented on the initiative of the user UT1, by means of the terminal TERu1.

Other implementations for step S100₂ are of course possible as already described in conjunction with FIG. 7A.

In S101₂, the device DF receives the request RQ31, via the interface IC.

In S102₂, the user UT1 accesses, via the interface COu of the application APu1, the set of bills ENS_F comprising in particular the bill FACᵢ that has “payable” status.

In S103₂, the user UT1 selects a payment method MP by means of the interface SPu.

Such a selection may of course be configured by the user UT1 before the execution of the method for validating the transaction, as a prerequisite.

In S104₂, by means of the interface DPu, the user UT1 sends the device DF a request RQ41 to activate the payment of part of the amount of the bill FACᵢ, said request RQ41 containing the identifier ID_LIST or ID_LIST1 depending on the implementation implemented, the amount of part of the bill FACᵢ and the selected payment method MP.

If the payment method MP is a proximity payment method, such as for example payment by cash, check, bank card, restaurant vouchers, or any other means of payment available to the provider FR, once the user UT1 has paid part of the bill FACᵢ using this payment method, in S105₂, the terminal TERf sends the device DF, via the network RC, by means of its interface ICf, a message M41 notifying of the validation of the payment of the amount of part of the bill FACᵢ, the message M41 containing the identifier ID_LIST (or ID_LIST1) and the amount of part of the bill FACᵢ.

If the payment method MP is a remote payment method, such as for example transfer, direct debit, remote payment by bank card, 3D Secure payment, payment via a telephone subscription bill, mobile-to-mobile payment or any other specific remote payment method, in S106₂, the device DF puts the terminal TERu1 in contact with a payment server SP in order to perform the remote payment by communicating, to the payment server SP, the identifier ID_LIST (or ID_LIST1) and the amount of part of the bill FACᵢ.

In S107₂, the payment server SP sends the device DF a message M51 notifying of the validation of the payment of the amount of part of the bill FACᵢ, the message M51 containing the identifier ID_LIST (or ID_LIST1) and the amount of part of the bill FACᵢ.

In S108₂, the device DF records the payment made.

Steps S100₂ to S108₂ are repeated so that the user UT2 pays the amount of the other part of the bill FACᵢ, using a payment method of their choice, using the identifiers ID_LIST or ID_LIST2 depending on the implementation implemented.

In S109₂, the device DF activates the update module MAJ in order to update the set ENS_F, by changing the “payable” status of the bill FACᵢ to “paid” status, and updates the amount due for the bills that have not yet been paid in the set ENS_F.

In S110₂, the device DF sends each of the terminals TERu1, TERu2 and TERf, via the network RC, by means of its interface IC, a message M61, M62 and M6 indicating that the bill FACᵢ has been paid. To that end, each message contains the identifier ID_LIST and an identifier of the bill FACᵢ.

### Description of a Second Embodiment of a Method for Validating a Transaction

With reference to FIG. 10B, the execution of a method for validating a transaction according to a second embodiment of the invention, implemented in the billing system of FIG. 8, will now be described.

In the example illustrated, the validation of the transaction corresponds to the payment of several bills of the set of bills ENS_F, for example the three bills FACᵢ, FACₘ and FACₚ. According to one example, the user UT1 uses their terminal TERu1 to pay the amount of the bill FACᵢ, while the user UT2 uses their terminal TERu2 to pay the amount of the bills FACₘ and FACₚ.

In S200₂, the terminal TERu1 sends, via the network RC, to the device DF, by means of the interface ICu, a request RQ′31 to pay the bill FACᵢ. To that end, the user UT1 activates the consultation interface COu, and enters the identifier ID_LIST or ID_LIST1 depending on the implementation implemented.

In S201₂, the device DF receives the request RQ′31, via the interface IC.

In S202₂, the user UT1 accesses, via the interface COu of the application APu1, the set of bills ENS_F comprising in particular the bill FACᵢ that has “payable” status.

In S203₂, the user UT1 selects a payment method MP by means of the interface SPu.

Such a selection may of course be configured by the user UT1 before the execution of the method for validating the transaction, as a prerequisite.

In S204₂, by means of the interface DPu, the user UT1 sends the device DF a request RQ′41 to activate the payment of the amount of the bill FACᵢ, said request RQ′41 containing the identifier ID_LIST or ID_LIST1 depending on the implementation implemented, the amount of the bill FACᵢ and the selected payment method MP.

If the payment method MP is a proximity payment method, such as for example payment by cash, check, bank card, restaurant vouchers, or any other means of payment available to the provider FR, once the user UT1 has paid the bill FACᵢ using this payment method, in S205₂, the terminal TERf sends the device DF, via the network RC, by means of its interface ICf, a message M′41 notifying of the validation of the payment of the amount of the bill FACᵢ, the message M′41 containing the identifier ID_LIST (or ID_LIST1) and the amount of the bill FACᵢ.

If the payment method MP is a remote payment method, such as for example transfer, direct debit, remote payment by bank card, 3D Secure payment, payment via a telephone subscription bill, mobile-to-mobile payment or any other specific remote payment method, in S206₂, the device DF puts the terminal TERu1 in contact with a payment server SP in order to perform the remote payment by communicating, to the payment server SP, the identifier ID_LIST (or ID_LIST1) and the amount of the bill FACᵢ.

In S207₂, the payment server SP sends the device DF a message M′51 notifying of the validation of the payment of the amount of the bill FACT, the message M′51 containing the identifier ID_LIST (or ID_LIST1) and the amount of the bill FACᵢ.

In S208₂, the device DF records the payment made.

Steps S200₂ to S208₂ are repeated so that the user UT2 pays the cumulative amount of the bills FACₘ and FACₚ, using a payment method MP of their choice, using the identifiers ID_LIST or ID_LIST2 depending on the implementation implemented.

In S209₂, the device DF activates the update module MAJ in order to update the set ENS_F, by changing the “payable” status of the bills FACᵢ, FACₘ and FACₚ to “paid” status, and updates the amount due for the bills that have not yet been paid in the set ENS_F.

In S210₂, the device DF sends each of the terminals TERu1, TERu2 and TERf, via the network RC, by means of its interface IC, a message M′61, M′62 and M′6 indicating that the bills FACᵢ, FACₘ and FACₚ have been paid. To that end, each message contains the identifier ID_LIST or ID_LIST1 and/or ID_LIST2 and an identifier of the bills FACᵢ, FACₘ and FACₚ.

The embodiments that have just been described above have been described by way of non-limiting examples. Numerous variations are of course possible. For example, the method for validating a transaction shown in FIGS. 10A and 10B is not limited to two user terminals UT1 and UT2. More than two users, and therefore more than two terminals TERu1 and TERu2, may be envisaged for making group purchases from the same provider FR. In another possible implementation, several providers, and therefore several provider terminals, may also be involved in the billing system of FIG. 8 in order to perform group sales to a single user or to several users.

In one particular application of the embodiments described in FIGS. 10A and 10B, the provider FR is for example a restaurateur, while the users UT1 and UT2 are for example two work colleagues who regularly have lunch at noon in the restaurant run by this restaurateur. The restaurateur FR proposes that they open a list and pay, for example, at the end of the week.

To that end:
The two colleagues UT1 and UT2 create a shared list and provide the identifier ID_LIST (or respectively ID_LIST1 and ID LIST2) thereof to the restaurateur FR.
After each meal, the restaurateur FR sends the device DF, via their terminal TERf, the bill for the two meals taken, said bill being added to the list of bills ENS_F.
On Friday, the colleagues UT1 and UT2 choose to pay the bills for the week themselves. The colleague UT1 pays half of the cumulative amount of the bills for the week, for example by paying by bank card, via the restaurateur's electronic payment terminal, and the other colleague UT2 decides to perform, for example, a SEPA instant transfer to pay the other half of those bills.
The restaurateur, via their terminal TERf, notifies the device DF that they have received the two payments.

1. A method for validating a transaction relating to an offer for a good or a service to at least one user, a bill having been generated for said offer, in which said method is implemented in a terminal associated with said user, wherein the method comprises the following, in a manner that is deferred with respect to said offer:
accessing, via a communication network, a billing device, using an identifier associated with a set of bills comprising said bill, the bills of said set relating to goods or services offered to said user by the same provider over a certain period of time; and
requesting, with the billing device, payment of at least said bill, taking into account said identifier, a payment method, and an amount written on said at least one bill.

2. The method for validating a transaction as claimed in claim 1. wherein said at least one bill is one of a plurality of bills to be paid in said set, said payment request takes into account said identifier, said payment method for some of the bills to be paid of said plurality, the cumulative amount of said certain bills, and at least one other payment method for the other bills to be paid of said plurality, and the cumulative amount of said other bills.

3. The method for validating a transaction as claimed in claim 1, wherein said at least one bill is one of a plurality of bills to be paid in said set, the method comprises the following at a terminal associated with another user sharing the payment of the bills of said set with said user:
accessing the billing device, via a communication network, using said identifier or another identifier associated with said set of bills, said identifier or said other identifier being associated with said other user; and
requesting, with the billing device, the payment of at least one other bill of said set, different from said at least one bill, taking into account said identifier or said other identifier, a payment method associated with said at least one other bill, and an amount written on said at least one other bill.

4. The method for validating a transaction as claimed in claim 1, wherein the time when the action of requesting payment with the billing device is triggered is configurable in the billing device.

5. The method for validating a transaction as claimed in claim 1, wherein said set of bills being associated with an identifier of the provider which has provided the good or the service to said at least one user, comprises the following at the billing device:
receiving, from a terminal associated with said provider, via a communication network, a message indicating that the payment of said at least one bill or of said bills of said set has been made to said provider; and
updating said set of bills, distinguishing the one or more bills still to be paid from said at least one bill that has or from said bills that have been paid.

6. A communication terminal for implementing validation of a transaction relating to an offer for a good or a service to at least one user, a bill having been generated for said offer, said terminal being associated with said user and comprising:
a processor that is configured to implement the following, in a manner that is deferred with respect to said offer:
accessing, via a communication network, a billing device, using an identifier associated with a set of bills comprising said bill, the bills of said set relating to goods or services offered to said user by the same provider over a certain period of time.
requesting, with the billing device, the payment of at least said bill, taking into account said identifier, a payment method, and an amount written on said at least one bill.

7. A billing device comprising;
a memory for storing bills; and
a processor that is configured to implement the following, in a manner that is deferred with respect to an offer for a good or a service to at least one user by a provider:
generating a bill relating to said offer, in response to a request received from a terminal associated with said provider, said request containing an identifier of said at least one user and an identifier of said provider,
storing the bill in said memory, said bill being added to a set of bills that relate to goods or services offered to said at least one user by said provider for a certain period of time, said set being associated with an identifier dependent on the identifiers received in the request,
receiving, from a terminal associated with said at least user, via a communication network:
a request to access the billing device, said access request comprising the identifier associated with said set.
a request for payment of at least said bill of said set. taking into account the identifier associated with said set. a payment method, and an amount written on said at least one bill,
activating said payment in response to the received payment request.

8. (canceled)

9. (canceled)

10. A non-transitory computer-readable information medium containing program code instructions stored thereon for implementing the method for validating a transaction, when the instructions are executed by a processor of a terminal associated with a user, wherein the transaction relates to an offer for a good or a service to at least the user, a hill having been generated for said offer, wherein the instructions configure the terminal to implement, in a manner that is deferred with respect to said offer;
accessing, via a communication network, a billing device, using an identifier associated with a set of bills comprising said bill, the bills of said set relating to goods or services offered to said user by the same provider over a certain period of time; and
requesting, with the billing device, payment of at least said bill, taking into account said identifier, a payment method, and an amount written on said at least one bill.
